(19) United States
(12) Patent Application Publication
(10) Pub. No.: US 2013/0301963 A1
(43) Pub. Date: Nov. 14, 2013

(54) AUTOMOTIVE POWERTRAIN COMPONENT AND BEARING WITH MICROPORES, AND METHOD THEREOF

(71) Applicants: Thomas A. Perry, Bruce Township, MI (US); Edward P. Becker, Brighton, MI (US); Emerson J. Adams, Sterling Heights, MI (US); Anil K. Sachdev, Rochester Hills, MI (US)

(72) Inventors: Thomas A. Perry, Bruce Township, MI (US); Edward P. Becker, Brighton, MI (US); Emerson J. Adams, Sterling Heights, MI (US); Anil K. Sachdev, Rochester Hills, MI (US)

(73) Assignee: GM GLOBAL TECHNOLOGY OPERATIONS LLC, Detroit, MI (US)

(21) Appl. No.: 13/469,656

(22) Filed: May 11, 2012

(51) Int. Cl. F16C 33/10; F16C 17/02; F01L 1/46

(52) U.S. Cl. 384/397; 29/898.042; 219/121.69

(57) ABSTRACT

One embodiment includes an automotive powertrain component and a bearing. The automotive powertrain component has a first surface and moves during use thereof. The bearing assists movement of the automotive powertrain component and has a second surface that opposes the first surface of the automotive powertrain component. Multiple micropores are located on a portion or more of the first surface, of the second surface, or of both the first and second surfaces. The micropores retain lubricant therein. In use, the lubricant can be lifted above respective openings of the micropores and into a space located between the first and second surfaces.

### TECHNICAL FIELD

The technical field generally relates to products including automotive powertrain component and bearing assemblies, and to ways of facilitating movement between automotive powertrain components and bearings.

### BACKGROUND

An automotive powertrain assembly typically includes numerous components that move during use of the associated automobile. A rotating camshaft is an example of such a component. Bearings are commonly used to facilitate this movement, such as a bushing and journal assembly used in conjunction with the camshaft. Customarily, a lubrication system is provided which includes a pump that supplies pressurized lubricant, such as oil, between the moving components and bearings.

### SUMMARY OF SELECT EMBODIMENTS OF THE INVENTION

One embodiment includes a product which may include an automotive powertrain component and a bearing. The automotive powertrain component may have a first surface and may be constructed and arranged to move during use of the automotive powertrain component. The bearing may be constructed and arranged to facilitate movement of the automotive powertrain component during use thereof. The bearing may have a second surface that may be constructed and arranged to oppose the first surface when the bearing is facilitating movement of the automotive powertrain component. Multiple micropores may be located on a portion or more of the first surface, of the second surface, or of both the first and second surfaces. The micropores may be constructed and arranged to retain lubricant therein. The retained lubricant may be lifted above respective openings of the micropores during use and into a space located between the first surface and the second surface.

One embodiment includes a method which may include providing an automotive powertrain component that has a first surface and may be constructed and arranged to move during use thereof. The method may also include providing a bearing that may be constructed and arranged to facilitate movement of the automotive powertrain component during use thereof. The bearing may have a second surface that may be constructed and arranged to oppose the first surface when the bearing is facilitating movement of the automotive powertrain component. And the method may include providing multiple micropores that may be located on a portion or more of the first surface, of the second surface, or of both the first and second surfaces. The micropores may be constructed and arranged to retain lubricant therein. The retained lubricant may be lifted above respective openings of the micropores during use of the automotive powertrain component and into a space located between the first surface and the second surface.

Other embodiments of the invention will become apparent from the detailed description provided hereinafter. It should be understood that the detailed description and specific examples, while disclosing illustrative embodiments of the invention, are intended for purposes of illustration only and are not intended to limit the scope of the invention.

### BRIEF DESCRIPTION OF THE DRAWINGS

Illustrative embodiments of the invention will become more fully understood from the detailed description and the accompanying drawings, wherein:

FIG. 1 is a perspective view of an illustrative embodiment of a camshaft.

FIG. 2 is a close-up view of illustrative micropores on a first surface.

FIG. 3 is an illustrative schematic cross-sectional view of the micropores of FIG. 2.

### DETAILED DESCRIPTION OF ILLUSTRATIVE EMBODIMENTS

The following description of the embodiment(s) is merely illustrative in nature and is in no way intended to limit the invention, its application, or uses.

The figures illustrate an automotive powertrain component and bearing assembly, such as a camshaft 10 with journals 12 and a mating bushing 11 (shown in phantom) that may have multiple micropores 14 therebetween to capture and retain lubricant, such as oil, and thus may help ease movement between the automotive powertrain component and the bearing. Because the micropores 14 may capture and retain lubricant, the camshaft 10 and bearing assembly may be effectively lubricated without the need of, and in the absence of, a customary pressurized lubrication system with a pressurized lubricant feed. Instead, a nonpressurized lubrication system, or passive lubricant circulation system, may be used. Some nonpressurized lubrication systems may dispose lubricant onto and between the associated surfaces by way of a so-called splash technique or process. Though shown and described in the context of the camshaft 10 and journals 12 and bushings 11, the construction and functionality of the micropores 14 could be implemented with other automotive powertrain components and bearings that move relative to each other such as a valve guide and a valve stem. Furthermore, the micropores 14 could be implemented in areas to facilitate movements other than rotational, such as translational, reciprocating, and sliding movement.

Furthermore, as used herein, the terms axially, radially, and circumferentially refer to directions with respect to the generally circular and cylindrical shape of the camshaft 10, so that the radial direction extends generally along any one of the imaginary radii of the shape, the axial direction is generally parallel to a center and longitudinal axis of the shape, and the circumferential direction extends generally along any one of the imaginary circumferences of the shape.

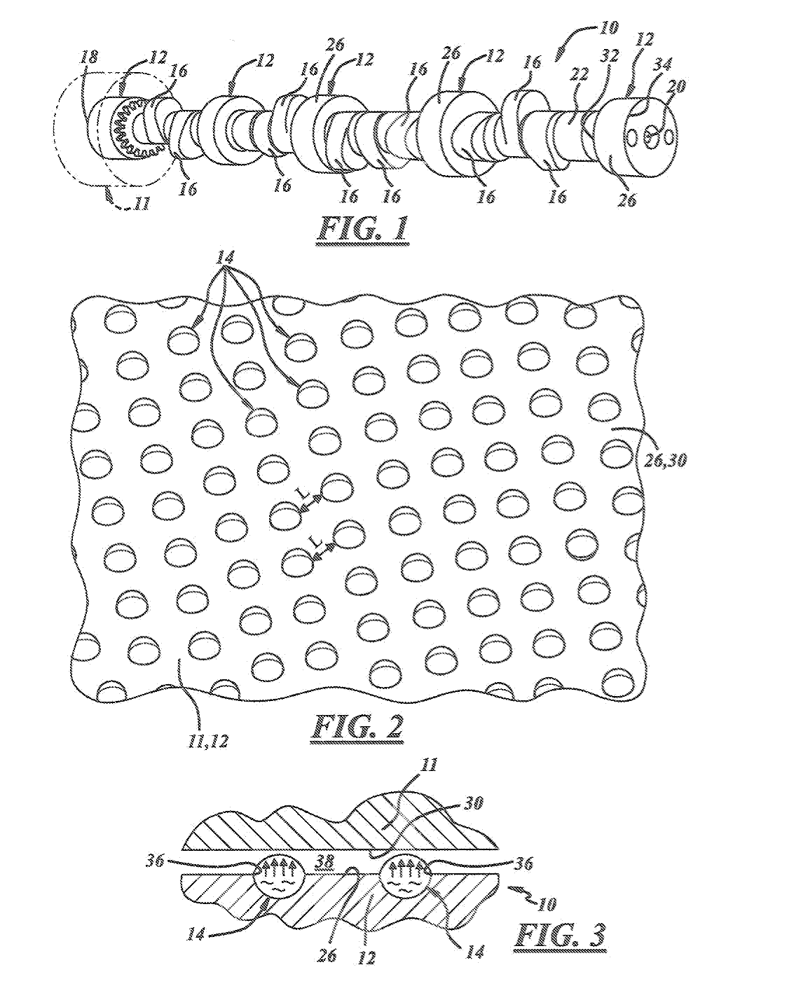

Referring to FIG. 1, in general the camshaft 10 may be a component of an automotive powertrain assembly, and in particular may be a component of an automotive internal combustion engine. In general use, the camshaft 10 may rotate about its longitudinal axis in order to engage and actuate poppet valves (not shown). In the illustrative embodiment, the camshaft 10 may include multiple cam lobes 16 protruding radially and outwardly away from its longitudinal axis and may directly engage the respective poppet valves. The cam lobes 16 may be spaced longitudinally apart from one another. The camshaft 10 may have a first end 18 and a second end 20, and may have an outer surface 22. Referring to FIG. 3, each journal 12 may have a journal surface 26. When in use, the journal surface 26 may be enveloped and surrounded by the respective bushing 11. Each journal 12 may have a first axial end 32 and a second axial end 34. The camshaft 10 may be composed of iron, steel, or another suitable material.

Referring again to FIG. 1, the bushings 11 may be equipped to the camshaft 10 and may be used to support and facilitate rotational movement of the camshaft. The bushings 11 themselves may be supported by or located in a structural component of the automotive powertrain assembly, and in particular by a structural component of the automotive internal combustion engine. There may be multiple bushings 11 that may be spaced apart from one another along the longitudinal axis of the camshaft 10. Each bushing 11 may be located at an individual journal 12 of the camshaft 10, and may be disposed circumferentially therearound. Each bushing 11 may be generally shaped as a sleeve, and may have an inner diameter or inboard surface 30. When facilitating movement of the camshaft 10, the inboard surface 30 may directly oppose and confront the journal surface 26.

In a customary pressurized lubrication system, a pump may deliver and maintain pressurized lubricant to a space located between a camshaft and a bushing. In some cases, where micropores are not utilized, the camshaft and bushing surfaces on each side of the space may squeeze or otherwise force the pressurized lubricant out of the space as the surfaces are moving relative to each other. This may result in dry surface-to-surface contact thereat which may cause increased friction and wear. And in some cases, the relatively complex and somewhat costly pressurized lubrication system may be undesirable; of course, the micropores 14 may be utilized with a camshaft and bushing that are subject to a pressurized lubrication system.

Referring to FIGS. 2 and 3, the micropores 14 may act as a reservoir that may retain and maintain lubricant therein. The lubricant may be retained and maintained for use at start-up of the associated automotive powertrain assembly, for use during continuous use of the automotive powertrain assembly, and may be retained therein after shutdown of the automotive powertrain assembly. The micropores 14 may be applied directly to a portion or more of the journal surface 26, of the inboard surface 30, or of both the journal and inboard surfaces. For example, the micropores 14 could be disposed on the inboard surface 30, and could extend on the journal surface 26 from the first axial end 32 to the second axial end 34; or could be disposed on only a central portion of the inboard surface away or on a central portion of the journal surface from the axial ends. The micropores 14 could also be disposed completely circumferentially around the inboard surface 30 and the journal surface 26. The micropores 14 may be applied to surfaces of automotive powertrain components with relatively tight tolerances, as is common for these components, and with curved or rounded surfaces. The micropores 14 may be applied by way of a texturing process such as a laser texturing process with an excimer laser or YAG laser, or may be applied by way or a metal-forming process such as a coining process.

Still referring to FIGS. 2 and 3, the micropores 14 may be spaced and arranged in a uniform and regular pattern with respect to one another. That is, the micropores 14 may be applied in a controlled manner so that they are equally spaced apart from one another by a distance L (FIG. 3), as opposed to an uncontrolled application with random spacing. Individual micropores 14 may be similarly sized and dimensioned with respect to one another. Individual micropores 14 may also be randomly sized and dimensioned with respect to one another. Each micropore 14 may have an optimized shape, depth, and frequency for effective functionality, as will be discussed below. For example, each micropore 14 may have a half-circle cross-sectional profile, a triangle cross-sectional profile, a cone cross-sectional profile, or the like. Each micropore 14 may have a diameter and depth, each ranging approximately between 1 microns to 100 microns. And each micropore 14 may have a density ranging between 1 micropore/mm² to 1 micropore/10 mm², and may be spaced 10 microns to 1000 microns apart from one another at their closest proximity. Of course, other shapes, dimensions, and frequencies are possible.

In use, the micropores 14 may, though need not, eliminate the need for a customary pressurized lubrication system with a pressurized and constant lubrication feed. Instead, the micropores 14 may facilitate the use of a nonpressurized lubrication system, or splash system. Upon movement of the automotive powertrain component and bearing, in this case rotation of the camshaft 10 journals 12, and bushings 11, the relative movement therebetween may produce a hydrodynamic state in which a lifting force is generated at the retained lubricant (represented by arrows in FIG. 3). The retained lubricant may be lifted through openings 36 and above the immediately surrounding journal surface 26, and into a space 38 located at an interface and between the inboard surface 30 and the journal surface 26. The lifting force and lubricant may keep the surfaces 30, 26 slightly apart from each other which may reduce friction and wear thereat.

Embodiment one may include an automotive powertrain component, a bearing, and multiple micropores. The automotive powertrain component may have a first surface and may be constructed and arranged to move during use of the automotive powertrain component. The bearing may be constructed and arranged to facilitate movement of the automotive powertrain component during use thereof. The bearing may have a second surface that may be constructed and arranged to oppose the first surface when the bearing is facilitating movement of the automotive powertrain component. The micropores may be located on a portion or more of the first surface, of the second surface, or of both the first and second surfaces. The micropores may be constructed and arranged to retain lubricant therein. The retained lubricant may be lifted above respective openings of the micropores during use and into a space located between the first surface and the second surface.

Embodiment two, which may be combined with embodiment one, further defines the automotive powertrain component as a camshaft and the bearing as a bushing and journal assembly. Also, the first surface is a journal surface of the camshaft and the second surface is an inboard surface of the bushing. And the plurality of micropores are located on the journal surface.

Embodiment three, which may be combined with any one of embodiments one to two, further defines the micropores as not being located on the inboard surface of the bushing.

Embodiment four, which may be combined with any one of embodiments one to three, further defines the camshaft and bushing as receiving lubricant from a nonpressurized lubrication system.

Embodiment five, which may be combined with any one of the embodiments one to four, further defines the micropores as being formed on the relevant portion(s) by way of a laser texturing process.

Embodiment six, which may be combined with any one of the embodiments one to five, further defines the micropores as being uniformly spaced and arranged with respect to one another and having substantially similar dimensions with respect to one another.

Embodiment seven, which may be combined with any one of the embodiments one to six, further defines the micropores as being uniformly spaced and arranged with respect to one another with a density ranging between one individual micropore per one square millimeter of area to one individual micropore per ten square millimeters of area.

Embodiment eight may include a method of providing an automotive powertrain component that has a first surface and may be constructed and arranged to move during use thereof. The method may also include providing a bearing that may be constructed and arranged to facilitate movement of the automotive powertrain component during use thereof. The bearing may have a second surface that may be constructed and arranged to oppose the first surface when the bearing is facilitating movement of the automotive powertrain component. And the method may include providing multiple micropores that may be located on a portion or more of the first surface, of the second surface, or of both the first and second surfaces. The micropores may be constructed and arranged to retain lubricant therein. The retained lubricant may be lifted above respective openings of the micropores during use of the automotive powertrain component and into a space located between the first surface and the second surface.

Embodiment nine, which may be combined with the embodiment eight, includes supplying lubricant to the space located between the first surface and the second surface by way of a no pressurized lubrication system.

Embodiment ten, which may be combined with any one of the embodiments eight to nine, further defines the automotive powertrain component as being a camshaft and the bearing as being a bushing and journal assembly. Further, the first surface is a journal surface of the camshaft and the second surface is an inboard surface of the bushing. And the micropores as being located on the journal surface.

Embodiment eleven, which may be combined with any one of the embodiments eight to ten, further defines the micropores as not being located on the inboard surface of the bushing.

Embodiment twelve, which may be combined with any one of the embodiments eight to eleven, further defines the micropores as being provided on the portion(s) by way of a laser texturing process.

Embodiment thirteen, which may be combined with any one of the embodiments eight to twelve, further defines the micropores as being uniformly spaced and arranged with respect to one another, and having substantially similar dimensions with respect to one another.

Embodiment fourteen, which may be combined with any one of the embodiments eight to thirteen, further defines the micropores as being randomly spaced and arranged with respect to one another, and having randomly differing dimensions with respect to one another.

Embodiment fifteen, which may be combined with any one of the embodiments eight to thirteen, further defines the micropores as being uniformly spaced and arranged with respect to one another with a spacing ranging between 10 microns to 1000 microns apart from one another at their closest proximity

The above description of embodiments of the invention is merely illustrative in nature and, thus, variations thereof are not to be regarded as a departure from the spirit and scope of the invention.

What is claimed is:

1. A product comprising:
an automotive powertrain component having a first surface, the automotive powertrain component constructed and arranged to move during use of the automotive powertrain component;
a bearing constructed and arranged to facilitate movement of the automotive powertrain component during use of the automotive powertrain component, the bearing having a second surface constructed and arranged to oppose the first surface when the bearing is facilitating movement of the automotive powertrain component; and
a plurality of micropores located on at least a portion of the first surface, of the second surface, or of both the first and second surfaces, the plurality of micropores constructed and arranged to retain lubricant therein, wherein the lubricant retained in the plurality of micropores is lifted above respective openings of the plurality of micropores during use of the automotive powertrain component and into a space located between the first surface and the second surface.

2. A product as set forth in claim 1, wherein the automotive powertrain component is a camshaft and the bearing is a bushing and journal assembly, wherein the first surface is a journal surface of the camshaft and the second surface is an inboard surface of the bushing, and wherein the plurality of micropores are located on the journal surface.

3. A product as set forth in claim 2, wherein the plurality of micropores are not located on the inboard surface of the bushing.

4. A product as set forth in claim 2, wherein the camshaft and the bushing receive lubricant from a nonpressurized lubrication system.

5. A product as set forth in claim 1, wherein the plurality of micropores are formed on the portion(s) via a laser texturing process.

6. A product as set forth in claim 1, wherein the plurality of micropores are uniformly spaced and arranged with respect to one another, and the plurality of micropores have substantially similar dimensions with respect to one another.

7. A product as set forth in claim 1, wherein the plurality of micropores are randomly spaced and arranged with respect to one another, and the plurality of micropores have randomly differing dimensions with respect to one another.

8. A product as set forth in claim 1, wherein the plurality of micropores are uniformly spaced and arranged with respect to one another with a density ranging between one individual micropore per one square millimeter of area, to one individual micropore per ten square millimeters of area.

9. A method comprising:
providing an automotive powertrain component having a first surface and being constructed and arranged to move during use of the automotive powertrain component, providing a bearing constructed and arranged to facilitate movement of the automotive powertrain component during use of the automotive powertrain component, the bearing having a second surface constructed and arranged to oppose the first surface when the bearing is facilitating movement of the automotive powertrain component, and providing a plurality of micropores located on at least a portion of the first surface, of the second surface, or of both the first and second surfaces, the plurality of micropores being constructed and arranged to retain lubricant therein, the lubricant retained in the plurality of micropores being lifted above respective openings of the plurality of micropores during use of the automotive powertrain component and into a space located between the first surface and the second surface.

10. A method as set forth in claim 8, further comprising:
supplying lubricant to the space located between the first surface and the second surface via a nonpressurized lubrication system.

11. A method as set forth in claim 8, wherein the automotive powertrain component is a camshaft and the bearing is a bushing and journal assembly, wherein the first surface is a journal surface of the camshaft and the second surface is an inboard surface of the bushing, and wherein the plurality of micropores are located on the journal surface.

12. A method as set forth in claim 10, wherein the plurality of micropores are not located on the inboard surface of the bushing.

13. A method set forth in claim 8, wherein the plurality of micropores are provided on the portion(s) via a laser texturing process.

14. A method as set forth in claim 8, wherein the plurality of micropores are uniformly spaced and arranged with respect to one another, and the plurality of micropores have substantially similar dimensions with respect to one another.

15. A method as set forth in claim 8, wherein the plurality of micropores are uniformly spaced and arranged with respect to one another at a density ranging between one individual micropore per one square millimeter of area, to one individual micropore per ten square millimeters of area.
